(19) United States
(12) Patent Application Publication
(10) Pub. No.: US 2011/0267435 A1
(43) Pub. Date: Nov. 3, 2011

(54) MULTIPLE VISION SYSTEM AND METHOD

(76) Inventor: Stéphane DESJARDINS, Blainville (CA)

(21) Appl. No.: 13/096,529

(22) Filed: Apr. 28, 2011

Related U.S. Application Data
(60) Provisional application No. 61/328,810, filed on Apr. 28, 2010.

(51) Int. Cl. H04N 13/02

(52) U.S. Cl. 348/47; 348/50; 348/E13.074

(57) ABSTRACT

A conveyer method and system comprising at least one conveyer unit conveying an object; a lighting unit; a vision unit; wherein the lighting unit illuminates the object in the line of sight of the vision unit as the vision unit takes at least a first image at a first angle and a second image at a second angle of each surface of the object on the conveyer unit.

### CROSS REFERENCE TO RELATED APPLICATIONS

This application claims benefit of U.S. provisional application Ser. No. 61/328,810, filed on Apr. 28, 2010. All documents above are incorporated herein in their entirety by reference.

### FIELD OF THE INVENTION

The present invention relates to a multiple vision system and method. More specifically, the present invention is concerned with a multiple vision system and method for identifying and classifying three-dimensional objects.

### BACKGROUND OF THE INVENTION

In the wood processing industry for example, wood grading and wood classification are important steps to sort out a variety of wood grades in accordance with specific applications.

Traditionally, grading of planed lumbers is done by a qualified operator. The operator examines and segregates the wood pieces according to a numeric grade such as grade 1, grade 2, and grade 3 following predetermined standards. This evaluation must be done very rapidly, generally at a rate of sixty pieces per minute per operator, according to several criteria and in adherence to stringent rules. Grading allows selecting and dispatching wood pieces according to the specific applications and to a client's needs, thereby allowing rationalizing the use of wood in a cost-effective way.

Typically, classification is done according to norms generated by national commissions with the purpose of obtaining uniform characteristics and quality throughout plants manufacturing a given type of wood. Obviously, the operators work under tremendous pressure. Moreover, evaluation standards used by the operators are so strict that they result in “over-quality”, meaning that approximately 15% of the wood pieces are over-classified, i.e. graded in an inferior grade, which in turn results in reduced profits. A number of technologies have been developed to automate the classification work. However, few have been successful in increasing the rate of classification and allowing reducing human intervention while maintaining the desired quality.

Indeed, a number of attempts have been made to simplify and accelerate wood classification. Since evaluation of an object requires that a peripheral surface thereof is evaluated, it has been contemplated positioning cameras above and under a conveyor carrying the wood pieces for example, but a recurrent problem is the accumulation of debris on lower cameras. In U.S. Pat. No. 5,412,220 issued to Moore in 1995, this problem is addressed by adding to the conveyor a mechanism to rotate each wood piece in such a way that all four longitudinal faces thereof can be exposed to a camera.

There is still a need in the art for a multiple vision system and method for identifying and classifying three-dimensional objects.

The present description refers to a number of documents, the content of which is herein incorporated by reference in their entirety.

### SUMMARY OF THE INVENTION

More specifically, in accordance with the present invention, there is provided a conveyer system comprising at least one conveyer unit conveying an object; a lighting unit; a vision unit; wherein the lighting unit illuminates the object in the line of sight of the vision unit as the vision unit takes at least a first image at a first angle and a second image at a second angle of each surface of the object on the conveyer unit.

There is further provided a method of imaging a 3D object conveyed on a conveyer unit, comprising illuminating the object in the line of sight of a vision unit and taking, by the vision unit, at least a first image at a first angle and a second image at a second angle of each surface of the object on the conveyer unit.

Other objects, advantages and features of the present invention will become more apparent upon reading of the following non-restrictive description of specific embodiments thereof, given by way of example only with reference to the accompanying drawings.

### BRIEF DESCRIPTION OF THE DRAWINGS

In the appended drawings:

FIG. 1 is a general side view of a system according to an embodiment of an aspect of the present invention;

FIG. 2 is a general perspective view of the system of FIG. 1;

FIG. 3 illustrates the angle-of-view of each camera according to an embodiment of an aspect of the present invention;

FIG. 4 illustrate corner detection according to an embodiment of an aspect of the present invention;

FIG. 5 illustrate a double vision system in a linear conveyer assembly according to an embodiment of an aspect of the present invention;

FIG. 6 shows a detail of a conveyer unit according to an embodiment of an aspect of the present invention;

FIG. 7 shows a detail of a conveyer unit according to an embodiment of an aspect of the present invention;

FIG. 8 shows a detail of a conveyer unit according to an embodiment of an aspect of the present invention;

FIG. 9 shows a lug on a conveyer belt or chain according to an embodiment of an aspect of the present invention;

FIG. 10 is a side view of a conveyer belt or chain according to an embodiment of an aspect of the present invention;

FIG. 11 shows a detail of a conveyer unit according to an embodiment of an aspect of the present invention; and

FIG. 12 illustrates a double vision system according to an embodiment of an aspect of the present invention.

### DESCRIPTION OF EMBODIMENTS OF THE INVENTION

In a nutshell, there is provided a conveyer system and method comprising at least one conveyer unit conveying an object; a lighting unit; a vision unit; with the lighting unit illuminating the object in the line of sight of the vision unit as the vision unit takes at least a first image at a first angle and a second image at a second angle of each surface of the object on the conveyer unit.

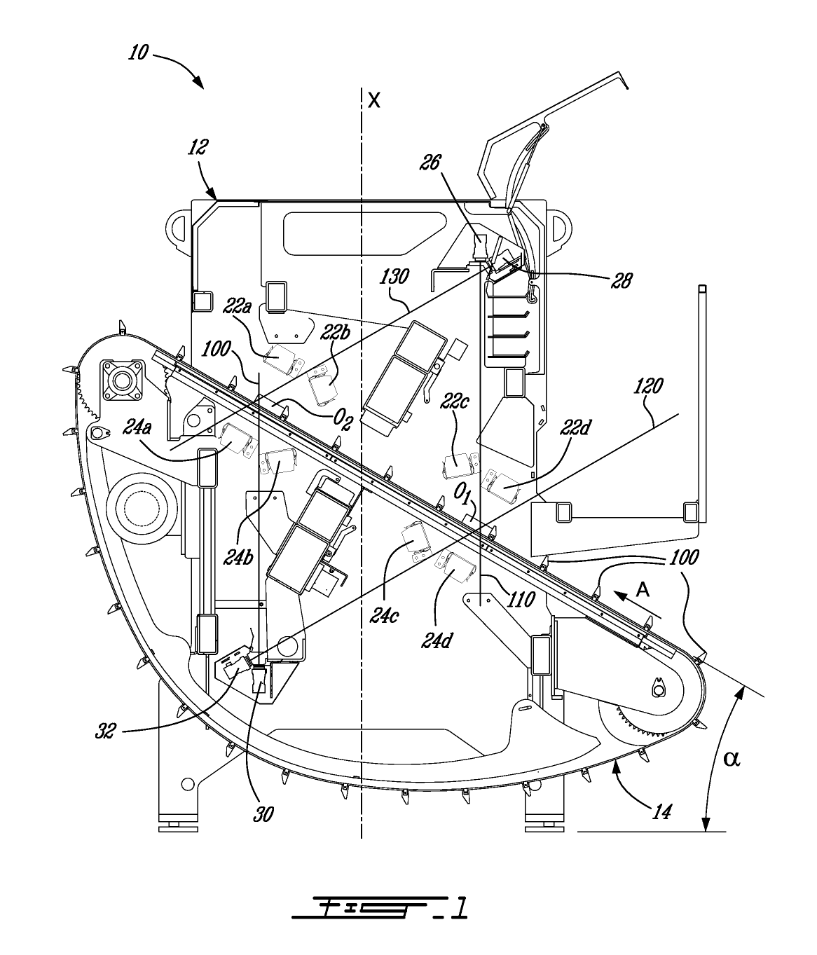

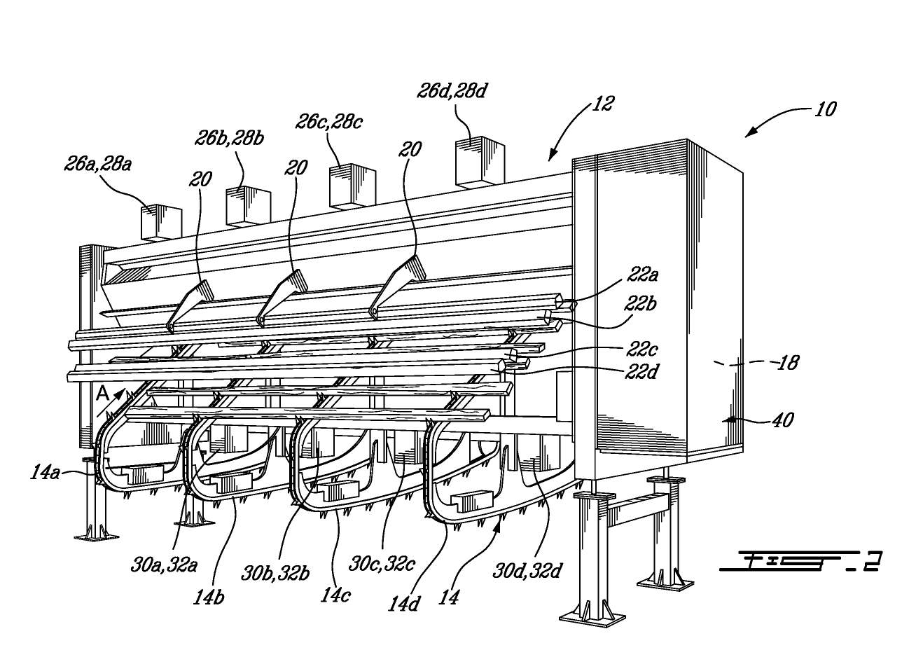

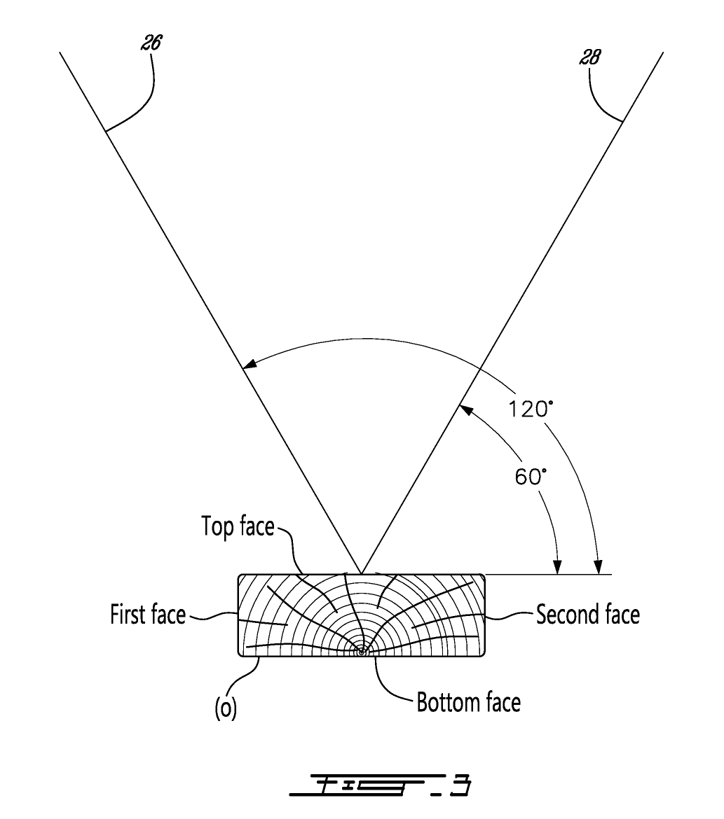

As illustrated in FIGS. 1 and 2 the appended drawings, a system 10 generally comprises a frame 12, a conveyor unit 14 (which movement is indicated by arrow A), a lighting unit, a vision unit and a processing unit. Such system is described in U.S. Pat. No. 7,227,165, included therein by reference.

The frame 12 is a robust structural body, generally metallic. It is shown here as supporting the conveyor unit 14 conveying objects, but the conveyer unit 14 may be self supported. The frame 12 may be provided with articulated arms 20, shown in FIG. 2 for example, extending and adjusting according to different angles.

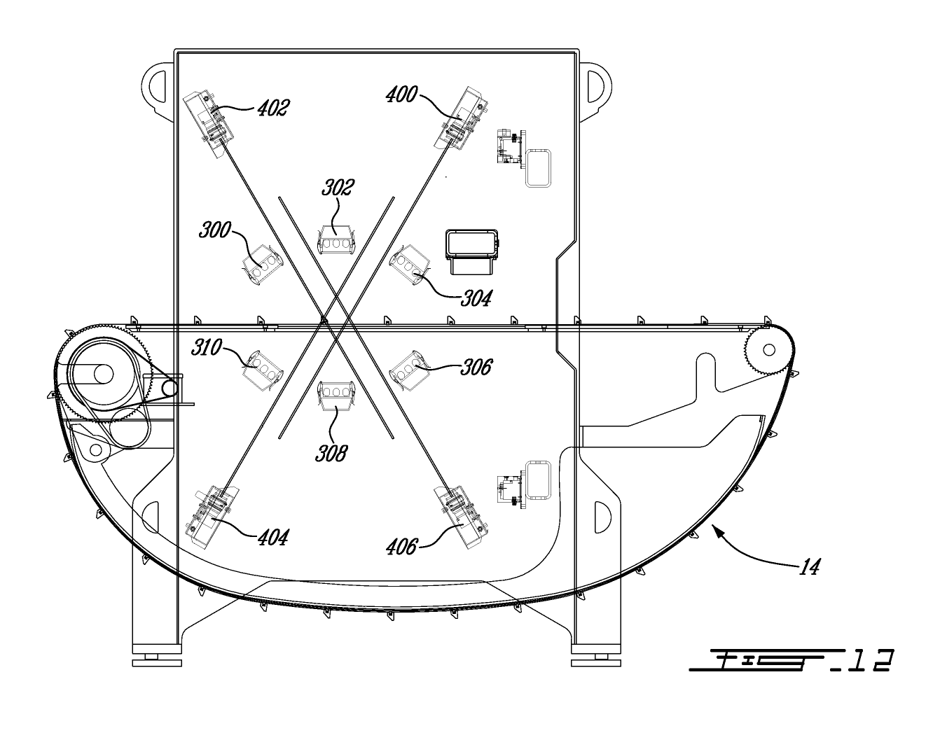

The conveyor unit 14 is shown in FIGS. 1 and 2 as a transversal conveyer unit 14 comprising conveying means, such as longitudinal belts or chains 14a, 14b, 14c and 14d for example transversally separated by a distance along the width of the conveyer unit 14, and supporting objects (O) to be analyzed with a minimum of contact points on the conveying means. The objects (O) are transported by the conveyer unit 14 transversally. Object transportation on the conveyor unit 14 may be performed with a minimum of conveyor unit length by adjusting the inclination slope α of the conveyor unit 14 relative to the horizontal (see FIG. 1), taking advantage of the fact that the inclination of the conveyor unit 14 is adjustable. For example, an inclination α of approximately 30°±15° relative to the horizontal is used in the embodiment illustrated in FIG. 1. It is to be noted that the conveyor unit 14 is also adjustable in length. As people in the art will appreciate, an horizontal conveyer unit 14 could be used, providing a rotation of the light and vision unit of the system (see for example FIG. 12).

The objects are generally 3D objects, comprising a top face, a bottom face and surfaces joining the top and bottom faces, referred to as edges. It is to be noted that the term “edges” as used herein refers to the sides of the 3D object, as opposed to the top face and the bottom face. The edges can be straight edges of 3D objects as illustrated in the Figures for clarity purposes, or less defined sides or transitions between a generally upper face and a generally lower face. Surfaces of the objects refer to the top face, the bottom face and the edges of the object.

The lighting and the vision units may be separate and remotely located from the frame 12.

In the embodiment illustrated in FIG. 1, the lighting unit comprises light sources 22c, 22d, 24c and 24d, is positioned upstream of the conveyor unit 14 and light sources 22a, 22b, 24a and 24b, is positioned downstream of the conveyor unit 14, with light sources positioned above the conveyer unit 14 (22c, 22d and 22a, 22b) and light sources positioned below the conveyer unit 14 (24c, 24d and 24a, 24b). The light sources may be light ramps supported by the articulated arms 20 or fixed to the frame 12.

It is to be noted that a different number of light sources may be used, in order to illuminate the surfaces of the objects, provided the different light sources generate contrast allowing to see defects of the objects. For example, it may be contemplated providing illumination on 360°, i.e. all around the conveyer unit 14.

The vision unit comprises cameras. The cameras may be permanently anchored on the frame 12 for example. The cameras may be color high-speed high-resolution line-scan cameras for example.

In the embodiment illustrated in FIG. 1, the cameras are assembled in two independent sub-units. A first sub-unit, comprising cameras 26 and 28, is positioned above the conveyor unit 14 and a second sub-unit, comprising cameras 30 and 32, is positioned below the conveyor unit 14. Each camera sub-unit is placed in a row transversally with regard to the frame 12, in such a way that a first camera of the sub-unit on a first side (above or below) of the conveyer unit 14 and a first camera of the sub-unit of the opposite side (below or above respectively) of the conveyer unit 14 read respectively the top face and a first edge of the object; and the bottom face and the first edge again of the object (see O₁ in FIG. 1). Then as the object moves forward (see arrow A and object noted as O₂ in FIG. 1), a second camera of the sub-unit on the first side of the conveyer unit 14 and a second camera of the sub-unit of the opposite side of the conveyer unit 14 read respectively the top face and a second edge of the object; and the bottom face and the second edge again of the object, in such a way that the resulting collected data as a whole correspond to the four surfaces (top and bottom faces, and leading and trailing edges) of the object, each of these four surfaces being read twice at different angles.

In the example of FIG. 1, cameras 26 and 32 read the top and the bottom faces, respectively, of the object (O₁) as it passes by and also read the leading edge (two readings for the leading edge). As the object is further conveyed (see arrow A), cameras 28 and 30 read the top and the bottom faces, respectively, again, of the same object (O₂), and also read the trailing edge (two readings for the trailing edge).

In each camera sub-unit, above and below the conveyor, the vision axis of each camera is inclined relatively to the conveyor unit movement axis (see arrow A FIGS. 1 and 2) to allow that each surface of the object is read at least twice, at different angles, as the object is being moved by the conveyor unit 14 from position O₁ to position O₂.

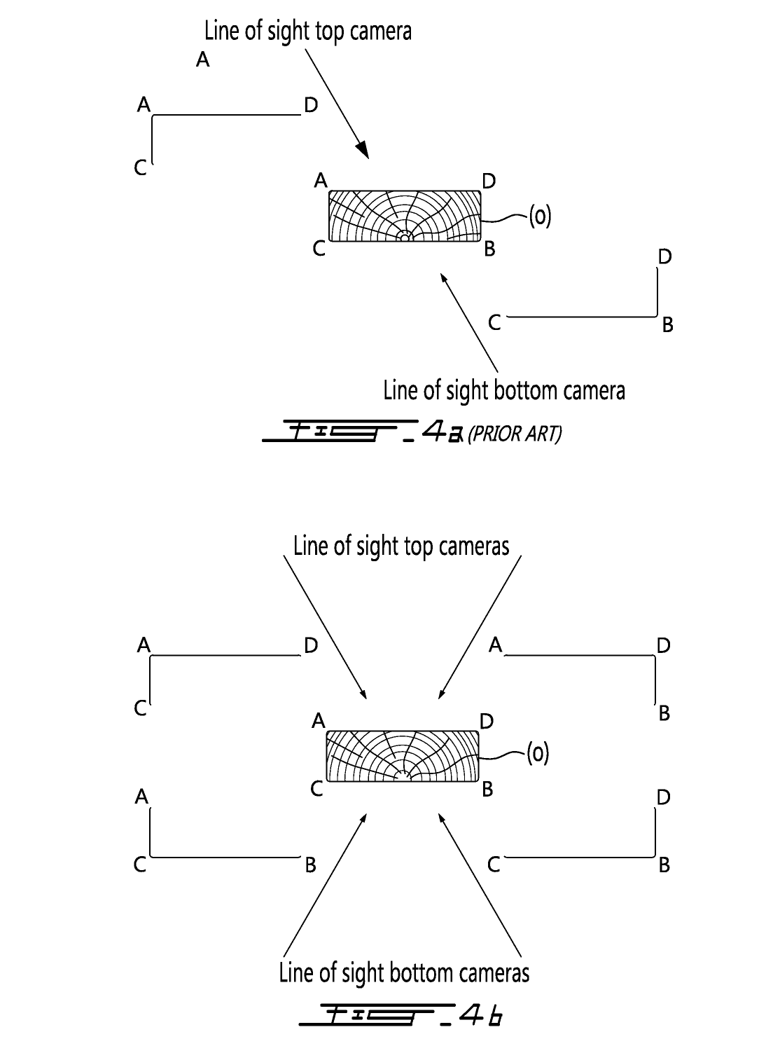

Moreover, on a given side (above or below) of the conveyer unit 14, the cameras of a sub-unit are arranged so that the angle-of-view of each camera is of 60°±15°/120°±15° in relation to the surface of the object facing this given side (above or below of the conveyer unit 14), as shown in FIG. 3.

The light sources are positioned to illuminate the object within the line of vision of each camera. In FIG. 1, in a given light sub-unit, three out of the four light sources are used in relation to each row of cameras. For example, in FIG. 1, light source 22c, 22d and 24c illuminate the object for camera 26, and light sources 22a, 22b and 24b illuminate for camera 28. As a result, two light source out of four are common to two rows of cameras (one on each side of the conveyer). For example, cameras 26 and 32 share light sources 22c and 24c, while light source 24d only relates to camera 32 and light source 22d only relates to camera 26. The sight line of each camera passes between two light sources of lights (see lines 100, 110, 120 and 130 in FIG. 1).

As people in the art will appreciate, a system according to the present invention thus comprises at least four cameras, two above the conveyer unit and two below the conveyer unit and light sources located above the conveyer unit and below the conveyer unit to illuminate the object placed on the conveyer within the line of sight of each of the cameras.

As described hereinabove, in the embodiment of FIG. 1, the light sources above and below the conveyer unit are separated into two groups, upstream (light sources 22c, 22d and 24c, 24d) and downstream (light sources 22a, 22b and 24a, 24b), and the object is imaged by the cameras at two positions O₁ and O₂.

In the embodiments described hereinabove, the vision unit and the lighting unit are distributed on both side of the conveyer unit 14. However, it could be contemplated using a vision unit and a lighting unit on one side of the conveyer unit 14 and moving the object upside down on the conveyer unit between different images.

The cameras are connected to computers (not shown) of the processing unit 18. In the embodiment illustrated in FIG. 2, the processing unit 18 is housed in a chamber 40 supported by the frame 12. Obviously, the processing unit 18 may alternatively be separately or remotely located from the frame 12. Typically, the processing unit 18 comprises a master computer, a plurality of independent high speed computers linked to the cameras, a module dedicated to shape and object identification, and an optimization computer (not shown). The processing unit 18 may monitor the location of the vision unit and/or of the vision sub-units as well as the inclination of the adjustable conveyor unit 14 as parameters; these data may be inputted either manually or automatically.

In a specific embodiment given by way of example, the lighting and the vision units are inclined at an angle relatively to the movement axis of the conveyor unit 14 and comprise 16 linear high speed color high resolution cameras divided into two vision sub-units located above and below the conveyor unit 14 as described hereinabove. The first vision sub-unit comprises a set of 8 cameras in pairs located in a row and distributed at intervals on the frame 12 along a transversal axis. This sub-unit comprises 4 pairs of cameras located at an angle of approximately 60°±15°/120°±15° above the conveyor unit 14 to collect data from the top face and the edges of the object to be analyzed. The second sub-unit comprises a set of 8 cameras in 4 pairs located in a row and distributed at intervals on the frame 12 along a transversal axis. This sub-unit comprises 4 pairs of cameras located at an angle of approximately 60°±15°/120°±15° below the conveyor unit 14 to collect data from the bottom face and the edges of the object to be analyzed.

Such a spatial configuration of the vision system allows to collect data on the four longitudinal sides (top and bottom faces and two edges) of the object to be analyzed, by allowing each vision sub-unit to collect data on three of the longitudinal surfaces.

Depending of the length of the objects for example, the number of pairs of cameras can be increased from 2 pairs (4 cameras), with the corresponding adjustment in the number of light sources, as described hereinabove. Other relative angles may be used.

The processing unit thus receives for processing, for each of the four surfaces (top and bottom faces and the edges) of each objet, two views at different angles, which allows an accurate detection of defects in each object, especially, in the case of wood pieces, of openings, such as shakes (i.e., typically, separations of wood fibers along the grain), seasoning checks (i.e., typically, lengthwise separations of the wood that usually extend across the rings of annual growth and commonly result from stresses set up in wood during seasoning), ring shakes (i.e., typically, shakes appearing in the heart of mature wood, directed along the annual rings and characterized by a large extension lengthwise along the pieces); splits (typically cracks originating at one given face and crossing the piece to any other face); and drying checks (typically crack occurring due to drying of the piece, which may occur anywhere of the piece and consist of a separation of the grains of the wood).

By doubling the number of cameras, or by increasing the number of points of view of each object, it is possible to analyze each object from a number of angles, as well as to have a better observation of all corners of each object.

The present system and method allow analyzing defects on a plurality of images taken with different shooting angles.

It has been found that the visual contrast of an opening in a 3D object such as a wood piece for example depends on the angle of view (by the cameras) in relation to the penetration angle of the opening in the piece and the angle of the lighting provided.

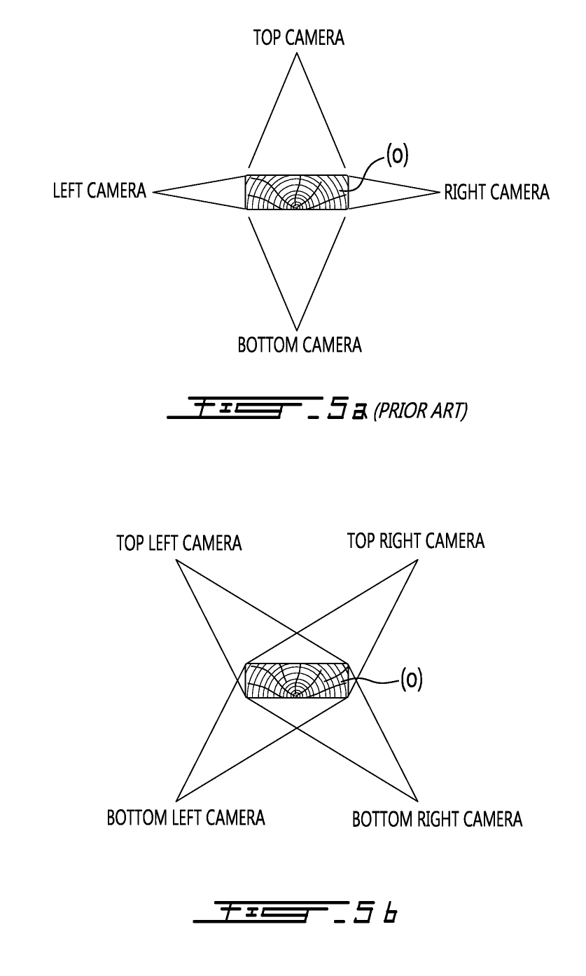

With the present vision system and method, the four corners A, B, C and D of an object are distinctly detected, since they are all in the line of sight of a camera (see arrows FIG. 4b), instead of only two corners A and B of the wood piece in the example of FIG. 4a in case of conventional single vision system since only these two corners are within the line of sight of cameras (top and bottom cameras) (see arrows FIG. 4a). As a result, detection of openings is increased, especially in the corners.

It is to be noted that the present system allows handling 3D objects of a variety of shape and geometry. In particular, the system may be adapted to a range of longitudinal wood pieces of different lengths and types (for example, rough, raw, planed or uncut) by obvious adjustment of the vision unit.

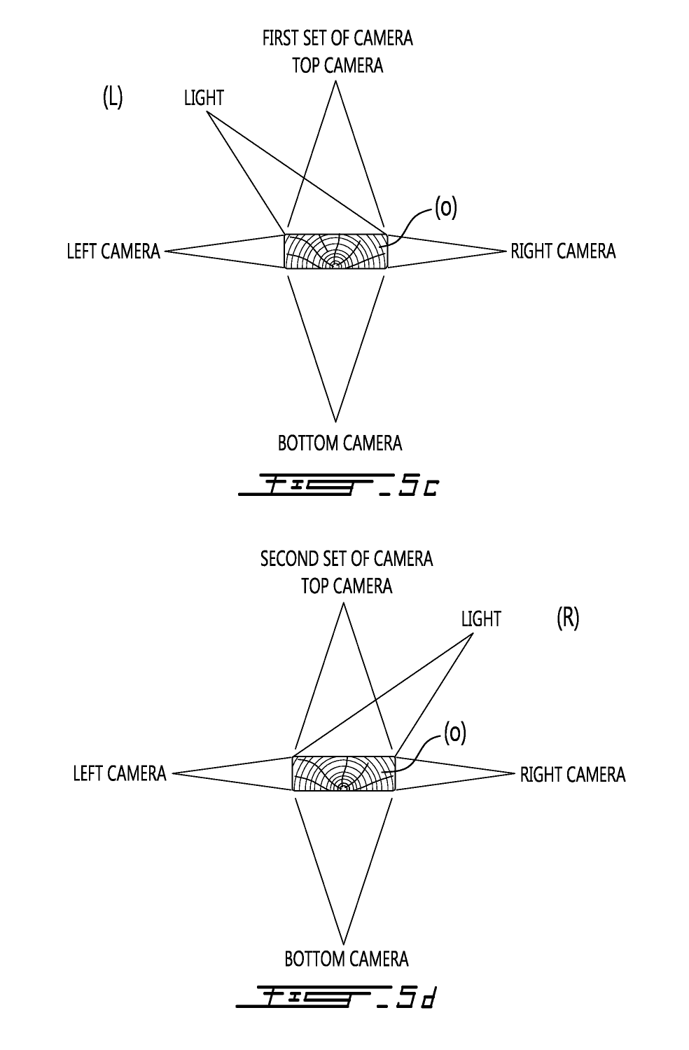

As people in the art will appreciate, although illustrated hereinabove in relation to a transversal conveyer system 10, the present vision system may be adapted to linear conveyer systems, in place of a conventional single vision system comprising one camera looking perpendicularly at each face of the wood piece, yielding one view per face (see FIG. 5a).

In FIG. 5b, the present vision system is used in a linear conveyer system, without modifying the lighting unit, so that each surface of the object (top and bottom faces and edges) is seen at different angles.

In FIGS. 5c and 5d, still in a linear conveyer system, two sets of four cameras are used along the path of the object for example, each camera looking perpendicularly at one corresponding surface of the object as standardly done in linear conveyer systems. At each location (L) and (R), the light unit provides different angles of illumination, so that each set of four cameras takes the same views once but with a different angles of illumination. Alternatively, a single set of cameras could be used, and two different illumination angles provided in sequence so that the same set of cameras takes the same views with a different angles of illumination.

The present invention thus provides obtaining, for each surface of the object, at least two images at different angles.

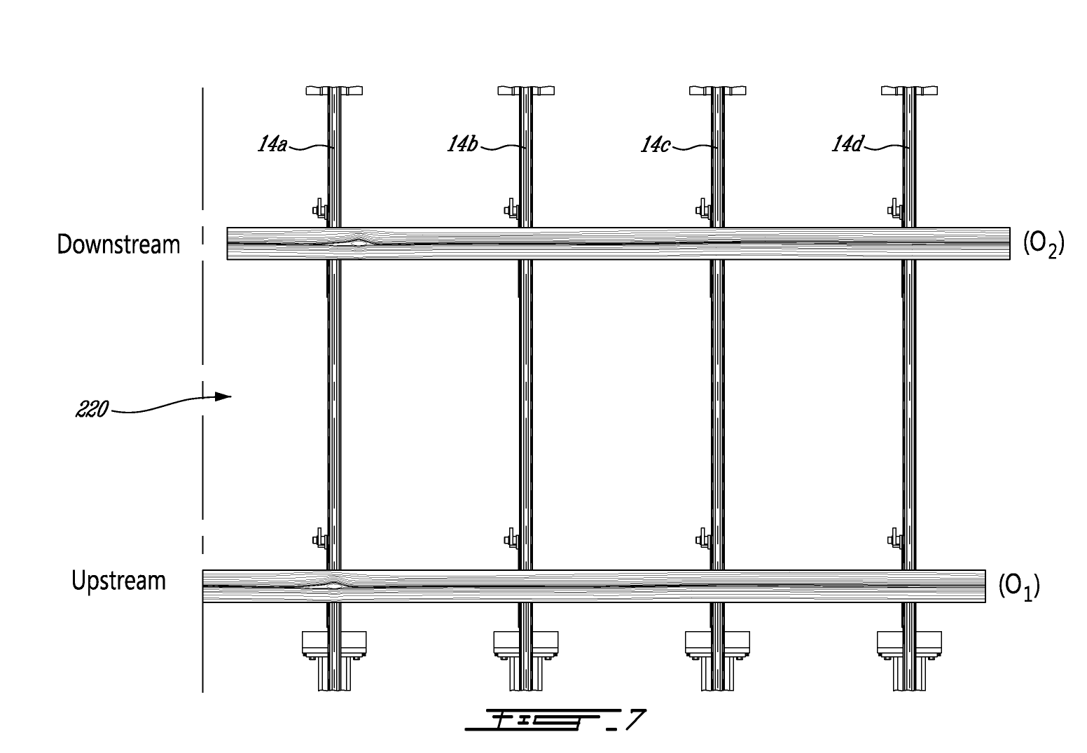

As the objects are conveyed on conveyer belts or chains 14a, 14b, 14c, 14d for example as described hereinabove, some parts of the object may be hidden from the cameras. In order to obtain images from these hidden parts, it may be contemplated longitudinally displacing each object, using a plate 220 for example, from O₁ to O₂ as shown in FIG. 7 for example, between the upstream and downstream light sub-units of FIG. 1 for example, so that the cameras can see in position O₂ parts that were hidden to them in position O₁.

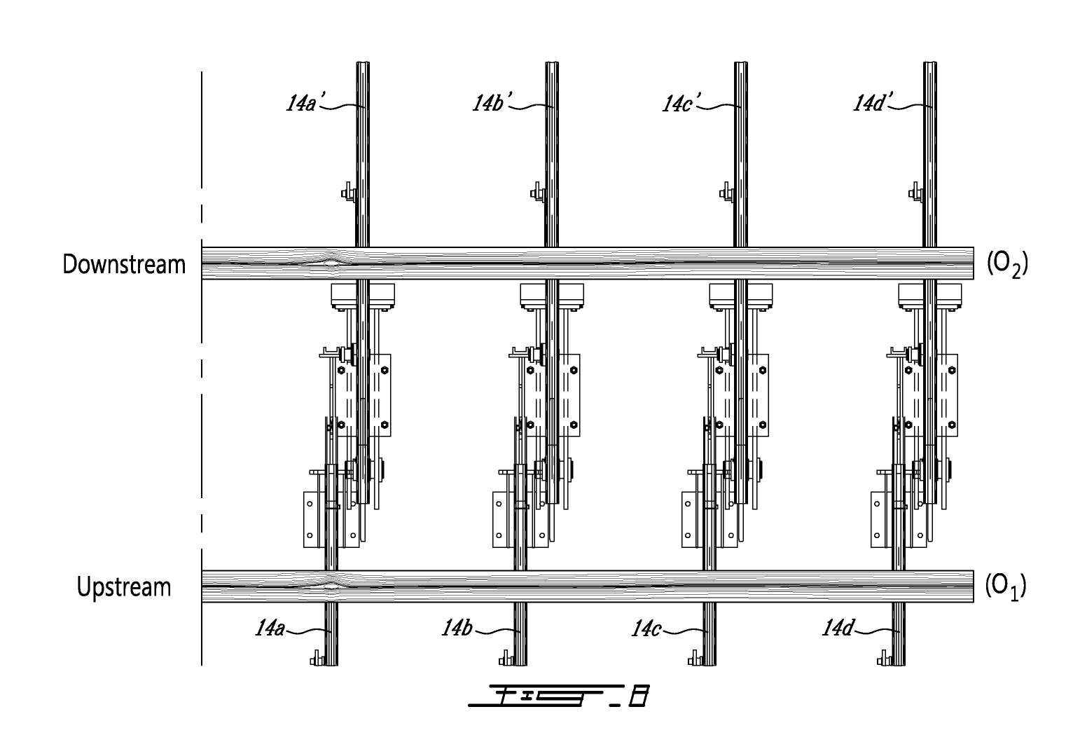

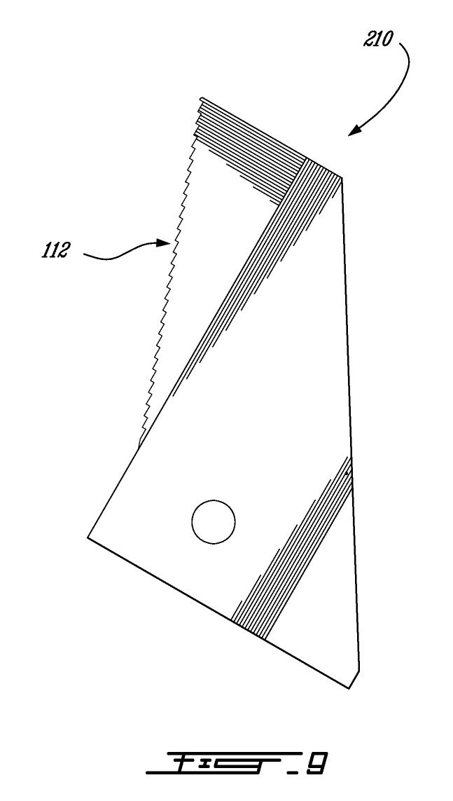

Alternatively, it may be contemplated interrupting the continuity of the conveyer unit 14 transversally, i.e. from 14a, 14b, 14c, 14d to 14a′, 14b′, 14c′, 14d′ as shown for example in FIG. 8, in order to allow obtaining at least one image of the remaining hidden parts of the object, thereby obtaining, on the whole, images of the entirety of the object.

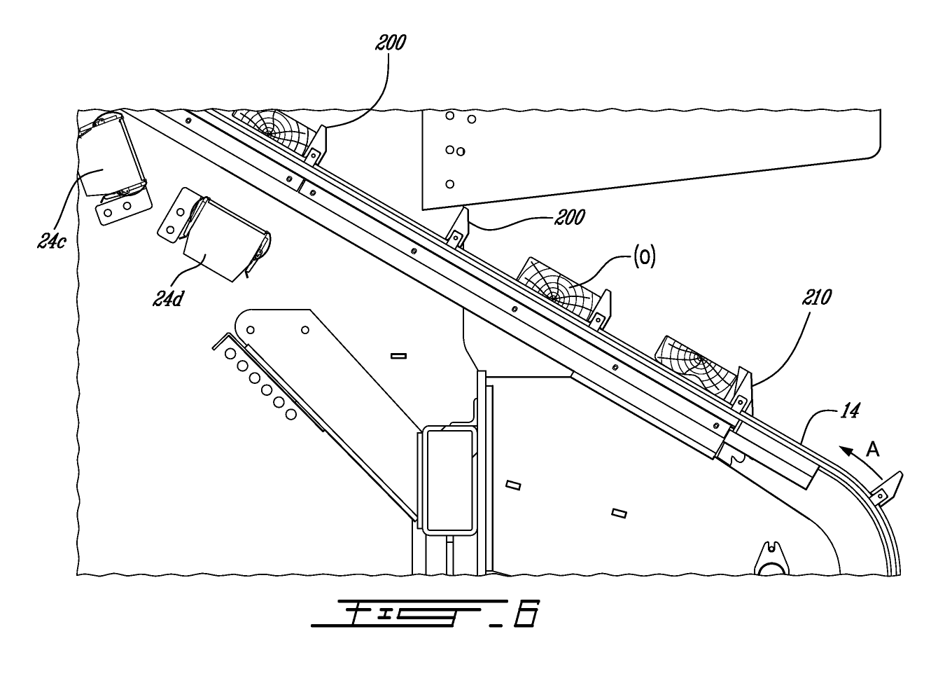

As shown in FIGS. 1 and 6, the objects are maintained, flat on a face, and perpendicularly, in position on the conveyer means of the conveyer unit 14 by lugs 200 running along the length of the conveyer means so as to form rows of lugs that abut one edge of an object (O) at intervals along the length of the object (see FIG. 2 for a general view). Lugs are usually short members extending perpendicularly to the surface of the conveyer means 14, as shown in 200 in FIGS. 1 and 6 for example.

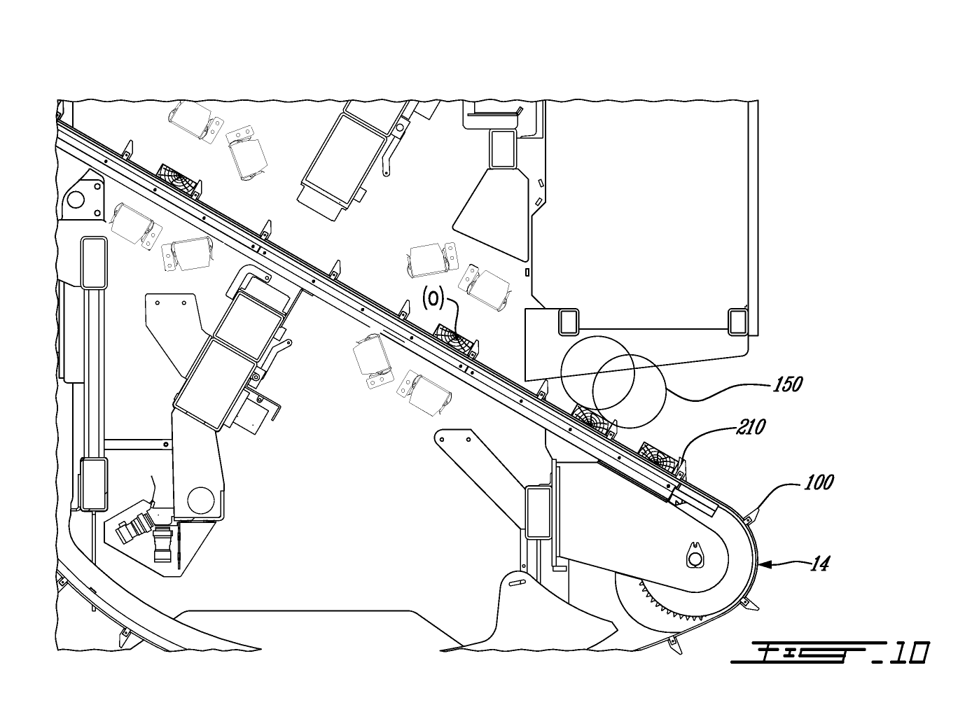

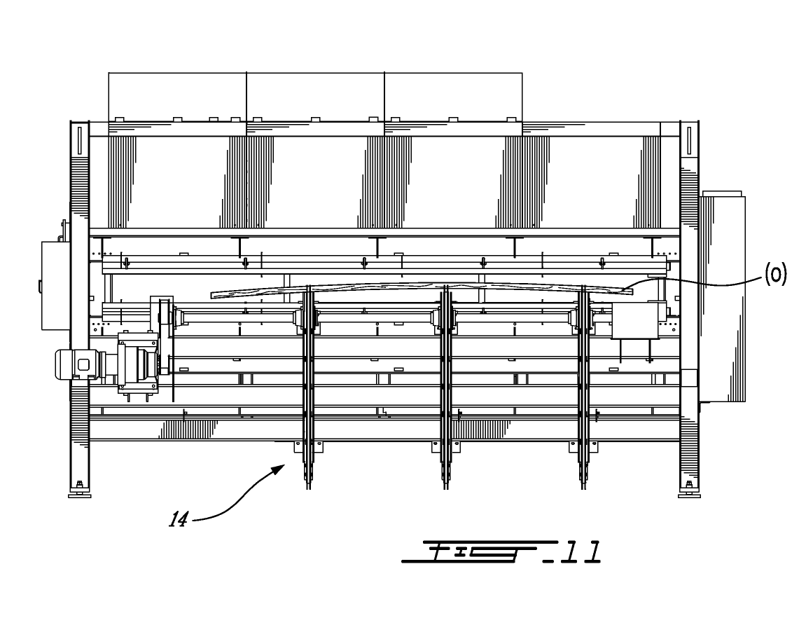

It has been found that lugs 210 having an angle relative to the surface of the conveyer means, as shown in FIGS. 6 and 10 for example, allow reducing or even preventing up and down movements of the conveyed objects, perpendicular to the surface of the conveyer means, even in cases when the bottom face of the objects shows curves and is not completely flat as shown in FIG. 11. Being inclined toward the object and toward the surface of the conveyer means, such lug 210 has a gripping-type action on the object. Such gripping action may even be increased by providing a rugged or toothed surface 112 of the face of the lug 210 that is inclined toward the object and toward the surface of the conveyer means, for example. Other shapes and structures for the lugs could be used, such as lugs with an radius of curvature towards the piece of wood and the surface of the conveyer means in a claw-like fashion for example.

FIG. 10 shows another method used to control up and down movements of the conveyed object perpendicular to the surface of the conveyer means, by using foam rolls 150 pressing on the top face of the conveyed object.

As people in the art will appreciate, reducing the vibration and movements of the conveyed objects as they are conveyed through the multiple vision unit allows precise detection.

According to another embodiment of the present invention, the system comprises cameras taking images of the object at one position (as opposed to two positions as described in relation to FIG. 1 for example). As illustrated in FIG. 13 for example, the vision unit comprises two cameras 400 and 402 above the conveyer unit 14, two cameras 404 and 406 below the conveyer unit 14. The lighting unit comprises light sources 300, 302, 304 above the conveyer unit 14 and light sources 306, 308 and 310 below the conveyer unit 14, each light source illuminating for two cameras as follows: camera 400 uses light source 302, 304 and 306; camera 402 uses light sources 302, 300 and 310; camera 404 uses light sources; and camera 406 uses light sources 306, 308 and 304. The cameras are line-can cameras, and the sight line of each camera passes between the beam of two light sources. The angle-of-view of each camera is 60°±15°/120°±15° relative to a surface above or under the object on the conveyer 14. As people in the art will appreciate, as compared to the embodiment of FIG. 1 for example, such a compact configuration uses fewer light sources while also allowing obtaining, for each surface of the object, two images at different angles, on a travel length reduced by at least half as compared with the distance between the positions O₁ and O₂ of the object in FIG. 1 for example.

Although the present invention has been described hereinabove by way of embodiments thereof, it can be modified, without departing from the nature and teachings of the subject invention as recited hereinbelow.

What is claimed is:

1. A conveyer system comprising at least one conveyer unit conveying an object; a lighting unit; a vision unit; wherein said lighting unit illuminates said object in the line of sight of said vision unit as said vision unit takes at least a first image at a first angle and a second image at a second angle of each surface of the object on said conveyer unit.

2. The conveyer system of claim 1, wherein said vision unit comprises a vision sub-unit positioned above the conveyer unit and a vision sub-unit positioned below, and said lighting unit comprises a lighting sub-unit positioned above the conveyer unit and a lighting sub-unit positioned below the conveyer unit.

3. The conveyer system of claim 1,
said vision unit comprising:
at least a first and a second cameras positioned above the conveyer unit; and
at least a first and a second cameras positioned below the conveyer unit;
said lighting unit comprising:
at least one light source above the conveyer unit; and
at least one light source below the conveyer unit;
wherein the object in the line of sight of each camera is illuminated by at least one light source above the conveyer unit and by one light source below the conveyer unit; and
wherein the first camera above the conveyer unit takes a first image of a top face of the object and a first image of a leading edge of the object, the second camera above the conveyer unit reads an second image of the top face and a first image of a trailing edge of the object, the first camera below the conveyer unit takes a first image of a bottom face of the object and a second image of leading edge, and the second camera below the conveyer unit takes a second image of the bottom face and a second image of the trailing edge, as the object passes by on said conveyer unit, each first and second images being at a different angle.

4. The conveyer system of claim 1, wherein said vision unit and said lighting unit are positioned on one side of the conveyer unit, said lighting unit illuminating said object, with a first surface thereof resting on said conveyer unit, in the line of sight of said vision unit as said vision unit takes first images of the object, and said lighting unit illuminating said object, with a second surface thereof opposite said first surface resting on said conveyer means, in the line of sight of said vision unit as said vision unit takes second images of the object.

5. The system of claim 1, wherein said light sources are separated into a downstream group comprising light sources above and below the conveyer unit and an upstream group comprising light sources above and below the conveyer unit;
wherein, in an upstream position on the conveyer unit, the object, in the line of sight of a camera positioned above the conveyer unit, is illuminated by the light unit, in the line of sight of a camera positioned below the conveyer unit is illuminated by the light unit; the camera above the conveyer unit taking a first image of a top face of the object and a first image of a leading edge of the object and the camera below the conveyer unit taking a first image of a bottom face of the object and a second image of the leading edge, as the object passes by on said conveyer unit between the light sources of said upstream group;
wherein, in a downstream position on the conveyer unit, the object, in the line of sight of a camera positioned above the conveyer unit is illuminated by the light unit and, in the line of sight of a camera positioned below the conveyer unit is illuminated by the light unit; the camera above the conveyer unit taking a second image of the top face and a first image the trailing edge of the object and the camera below the conveyer unit taking a second image of the bottom face and a second image of the trailing edge of the object, as the object passes by on said conveyer unit between said light sources of said downstream group.

6. The system of any one of claim 1, wherein the vision unit comprises cameras on each side of the conveyer unit placed in a row transversally with regard to said conveyer unit.

7. The system of claim 6, wherein, above and below the conveyer respectively, a vision axis of each camera is inclined relatively to said conveyer unit movement axis.

8. The system of claim 3, wherein each camera reads two surfaces of the object as the object is being moved by the conveyer unit.

9. The system of claim 3, wherein, on a given side of the conveyer unit, the cameras are arranged so that an angle-of-view of each camera is of 60°±15°/120°±15° in relation to a surface of the object facing this given side.

10. The system of claim 1, wherein the inclination of said conveyer unit is adjustable.

11. The system of claim 1, wherein said lighting and vision units are inclined at an angle relatively to a movement axis of the conveyer unit.

12. The system of claim 1, wherein said vision unit comprises 16 linear high speed colour high resolution cameras divided into two vision sub-units located above and below the conveyer unit respectively, a first vision sub-unit comprising a set of 8 cameras in pairs located in a row and distributed at intervals along a transversal axis; a second sub-unit comprising a set of 8 cameras in 4 pairs located in a row and distributed at intervals along the transversal axis.

13. The system of claim 12, wherein said first vision sub-unit comprises 4 pairs of cameras located at angle of about 60°±15°/120°±15° on each side of the conveyer unit; and said second sub-unit comprises 4 pairs of cameras located at angle of about 60°±15°/120°±15° on each side of the conveyer unit.

14. The system of claim 1, comprising a processing unit, wherein said processing unit receives, for each surface of the object, at least two images, each at a different angle.

15. The system of claim 1, wherein all corners of the object are in the line of sight of at least one camera.

16. The system of claim 1, wherein said conveyer unit is a transversal conveyer unit.

17. The system of claim 16, wherein said transversal conveyer unit comprises longitudinal conveying means transversally separated by an adjustable distance along a width of the conveyer unit.

18. The system of claim 1, wherein said conveyer unit is a linear conveyer unit.

19. A method of imaging a 3D object conveyed on a conveyer unit, comprising illuminating the object in the line of sight of a vision unit and taking, by the vision unit, at least a first image at a first angle and a second image at a second angle of each surface of the object on the conveyer unit.

20. The method of claim 19, comprising positioning a first vision sub-unit above the conveyer unit and a second vision sub-unit below the conveyer unit, and positioning a lighting sub-unit above the conveyer unit and a lighting sub-unit below the conveyer unit.

21. The method of claim 19, comprising:
positioning a lighting unit on one side of the conveyer unit;
illuminating, by the lighting unit, the object, with a first surface thereof resting on the conveyer unit, in the line of sight of the vision unit;
taking, by the vision unit, first images of the object;
moving the object upside down on the conveyer unit;
illuminating, by the lighting unit, the object, with a second surface thereof opposite the first surface resting on the conveyer unit, in the line of sight of the vision unit;
taking, by the vision unit, second images of the object.

22. The method of claim 19, comprising:
providing at least a first and a second cameras positioned above the conveyer unit;
providing at least a first and a second cameras positioned below the conveyer unit;
illuminating the object in the line of sight of each camera by at least one light source above the conveyer unit and by one light source below the conveyer unit;
taking an image of the top face of the object at a first angle and an image of the leading edge of the object at a first angle by the first camera above the conveyer unit, an image of the top face at a second angle and an image of the trailing edge at a first angle by the second camera above the conveyer unit, an image of the bottom face at a first angle and an image of the leading edge at a second angle by the first camera below the conveyer unit, and an image of the bottom face at a second angle and an image of the trailing edge at a second angle by the second camera below the conveyer unit, as the object passes by on the conveyer unit.

23. The method of claim 22, wherein said taking images of the object comprises:
taking images of the object by a first set of cameras positioned above the conveyer unit and a second set of cameras positioned below the conveyer unit; each light source illuminating for the cameras of the first set and for the cameras of the second set; and the cameras of the first set and the cameras of the second reading the top face, the bottom and a first edge of the object, as the object passes on the conveyer unit;
moving the object;
taking images of the object by a third set of cameras positioned above the conveyer unit and a fourth set of cameras positioned below the conveyer unit; each light source illuminating for the cameras of the third set and for the cameras of the fourth set; and the cameras on the third and fourth sets reading respectively the top face, the bottom face and the second edge of the object as the object passes on the conveyer unit.

24. The method of claim 22, said taking images of the object comprises:
taking images of the object by a first set of cameras positioned above the conveyer unit and a second set of cameras positioned below the conveyer unit; the light sources illuminating for the cameras; and the cameras of the first set and the cameras on the cameras of the second set reading the top face, the bottom face and an edge, as the object passes on the conveyer unit;
stopping the conveyer unit and modifying a transverse position of the longitudinal conveying means of the conveyer unit;
taking images of the object by the first set of cameras and by the second set of cameras; each light source illuminating for the cameras; and the cameras of the first set and the cameras of the second set reading the top face, the bottom face and an edge of the object, as the object passes on the conveyer unit.

25. The method of claim 22, wherein said illuminating the object comprises using first light sources positioned upstream of the conveyer unit and second light sources positioned downstream of the conveyer unit, each light source comprising lights above the conveyer unit and lights below the conveyer unit; and said taking images of the object comprises using cameras positioned above the conveyer unit and cameras positioned below the conveyer unit.

26. The method of claim 22, wherein said taking images of the object comprises the cameras of the camera sub-unit on a first side of the conveyer unit and the cameras of the camera sub-unit of the opposite side of the conveyer unit reading respectively the top face and the edges of the object; and the bottom face and the edges of the object.

27. The method of claim 22, wherein said taking images of the object comprises a first camera of the first camera sub-unit and a first camera of the second camera sub-unit reading the top face and the bottom face respectively, and also each one reading the first edge of the object as it passes by; and a second camera of the first camera sub-unit and a second camera of the second camera sub-unit reading the top and the bottom faces respectively, and also each one reading the second edge of the object as it passes by.

28. The method of claim 22, wherein said taking images comprises:
using a first camera sub-unit comprising a set of cameras located in a row and distributed at intervals along a transversal axis, with pairs of cameras being located at an angle of 60°±15°/120°±15° on each side of the conveyer unit; and
using a second camera sub-unit comprising a set of cameras located in a row and distributed at intervals along a transversal axis, with pairs of cameras located at an angle of 60°±15°/120°±15° on each side of the conveyer unit.
